(19) United States
(12) Patent Application Publication
(10) Pub. No.: US 2022/0335255 A1
(43) Pub. Date: Oct. 20, 2022

(54) DATASET-FREE, APPROXIMATE MARGINAL PERTURBATION-BASED FEATURE ATTRIBUTIONS

(71) Applicant: Oracle International Corporation, Redwood Shores, CA (US)

(72) Inventors: ZAHRA ZOHREVAND, Vancouver (CA); YASHA PUSHAK, Vancouver (CA); TAYLER HETHERINGTON, Vancouver (CA); KAROON RASHEDI NIA, Vancouver (CA); SANJAY JINTURKAR, Santa Clara, CA (US); NIPUN AGARWAL, Saratoga, CA (US)

(21) Appl. No.: 17/232,671

(22) Filed: Apr. 16, 2021

(51) Int. Cl. G06K 9/62; G06N 20/00

(52) U.S. Cl. CPC G06K 9/6228; G06K 9/6259; G06N 20/00

(57) ABSTRACT

In an embodiment, a computer assigns a respective probability distribution to each of many features that include a first feature and a second feature that are assigned different probability distributions. For each original tuple that are based on the features, a machine learning (ML) model infers a respective original inference. For each feature, and for each original tuple, the computer: a) generates perturbed values based on the probability distribution of the feature, b) generates perturbed tuples that are based on the original tuple and a respective perturbed value, c) causes the ML model to infer a respective perturbed inference for each perturbed tuple, and d) measures a respective difference between each perturbed inference and the original inference. A respective importance of each feature is calculated based on the differences measured for the feature. Feature importances may be used to rank features by influence and/or generate a global or local ML explainability (MLX) explanation.

### RELATED CASE

The following references are incorporated herein in their entirety.
U.S. patent application Ser. No. ______ titled LOCAL PERMUTATION IMPORTANCE: A STABLE, LINEAR-TIME LOCAL MACHINE LEARNING FEATURE ATTRIBUTOR filed on ______ by Yasha Pushak et al;
STATISTICAL FUNCTIONS (scipy.stats) published Feb. 18, 2021, available at https://docs.scipy.org/doc/scipy-1.6.1/reference/stats.html

### FIELD OF THE INVENTION

The present invention relates to machine learning (ML) explainability (MLX). Herein are explanation techniques for black box ML models based on selection of probability distributions for perturbation.

### BACKGROUND

Machine learning (ML) and deep learning are becoming ubiquitous for two main reasons: their ability to solve complex problems in a variety of different domains and growth in performance and efficiency of modern computing resources. However, as the complexity of problems continues to increase, so too does the complexity of the ML models applied to these problems.

Deep learning is a prime example of this trend. Other ML algorithms, such as neural networks, may only contain a few layers of densely connected neurons, whereas deep learning algorithms, such as convolutional neural networks, may contain tens to hundreds of layers of neurons performing very different operations. Increasing the depth of the neural model and heterogeneity of layers provides many benefits. For example, going deeper can increase the capacity of the model, improve the generalization of the model, and provide opportunities for the model to filter out unimportant features, while including layers that perform different operations can greatly improve the performance of the model. However, these optimizations come at the cost of increased complexity and reduced human interpretability of model operation.

Explaining and interpreting the results from complex deep learning models is a challenging task compared to many other ML models. For example, a decision tree may perform binary classification based on N input features. During training, the features that have the largest impact on the class predictions are inserted near the root of the tree, while the features that have less impact on class predictions fall near the leaves of the tree. Feature importance can be directly determined by measuring the distance of a decision node to the root of the decision tree.

Such models are often referred to as being inherently interpretable. However, as the complexity of the model increases (e.g., the number of features or the depth of the decision tree increases), it becomes increasingly challenging to interpret an explanation for a model inference. Similarly, even relatively simple neural networks with a few layers can be challenging to interpret, as multiple layers combine the effects of features and increase the number of operations between the model inputs and outputs. Consequently, there is a requirement for alternative techniques to aid with the interpretation of complex ML and deep learning models.

ML explainability (MLX) is the process of explaining and interpreting ML and deep learning models. MLX can be broadly categorized into local and global explainability:
Local: Explain why an ML model made a specific prediction corresponding to a given sample to answer a question such as why did the ML model make a specific prediction.
Global: Understand the general behavior of the ML model as a whole to answer questions such as how does the ML model work or what did the ML model learn from training data.

### BRIEF DESCRIPTION OF THE DRAWINGS

In the drawings:

FIG. 1 is a block diagram that depicts an example computer that provides machine learning (ML) explainability (MLX) for a black box ML model based on selection of probability distributions for perturbation;

FIG. 2 is a dataflow diagram that depicts example supervised difference measurement and importance scoring;

FIG. 3 is a flow diagram that depicts an example computer process that can provide MLX for a black box ML model based on selection of probability distributions for perturbation;

FIG. 4 is a flow diagram that depicts an example computer process for generating an MLX explanation for an ML model;

FIG. 5 is a flow diagram that depicts an example computer process that scores features for importance;

FIG. 6 depicts example pseudocode that initializes probability distributions by selecting a best fitting probability distribution respectively for each feature;

FIG. 7 is a block diagram that illustrates a computer system upon which an embodiment of the invention may be implemented;

FIG. 8 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Herein are explanation techniques that extract global or local feature importance for a trained machine learning (ML) or deep learning (DL) model, referred to as a black box model. To explain the behavior of the ML model, perturbation-based ML explanation (MLX) techniques evaluate how the predictions of the ML model change on perturbed versions of a given dataset. A feature that, when perturbed, has a much larger effect on the ML model's predictions is considered to be more important than a perturbed feature that results in little-to-no change in the ML model's predictions.

Techniques herein may fit one parametric distribution to each feature's empirical marginal training distribution while the ML model is being trained. In particular, for each numeric-valued feature, fitting several different parametric distributions (e.g., a normal distribution, a beta distribution, and a gamma distribution) is attempted and compared by using a statistical test such as the Kolmogorov-Smirnov test to pick the best-fit distribution respectively for each feature. For any features for which no features can be found to fit the data well, a uniform distribution can be used as a fall back. For categorical features, the distributions can be obtained by memorizing the relative frequency of the data-instances with a same feature value.

These parametric marginal distributions can be saved and later used when computing perturbation-based feature attributions. In particular, any time a perturbation-based feature attributor would normally sample a feature value from the empirical marginal distribution of a reference dataset, instead the corresponding feature's parametric marginal distribution can be used to generate a new random value for the feature that is still consistent with the original feature's marginal distribution. Maintaining this distribution may be important for two reasons. The first is increased realism that avoids assessing the importance of a feature completely outside the domain of realistic values (e.g., a negative value for a weight feature). The second is generality that avoids over-representing the importance of feature values that occur in only a small fraction of the data samples. Using parametric marginal distributions removes the requirement that a reference data distribution be available to an explanation technique when an MLX explanation is computed.

Use of sampling from a set of pre-fit parametric marginal distributions to perturb feature values for perturbation-based feature attribution can generate more accurate explanations than sampling from the empirical marginal distribution of a reference training/validation/test dataset. As a generator of measurably more accurate MLX explanations by this approach, a computer is quantitatively more reliable. That is, the reliability of the explanation computer itself is increased.

This approach allows perturbation-based feature attribution in scenarios where a reference training/validation/test dataset may not be available due to security, privacy, memory, input/output (I/O) bandwidth, or other computer resource constraints. This approach comes with an additional advantage when parallelized. Often one of the most expensive operations (bottlenecks) in parallel algorithms is the time required to copy/move large amounts of data to each of the parallel workers. However, since this approach does not require a large dataset from which to sample feature values, that cost is almost completely removed, as the size of the feature generators will typically be several orders of magnitude smaller than most datasets. In other words, techniques herein decrease demand for computer resources such as time and space without sacrificing accuracy of MLX explanations. That is, the explanation computer itself is accelerated and its data footprint is decreased, both of which are quantifiable computer performance improvements.

For example, the sampled feature values (for numeric-valued features) will no longer be restricted to the discrete set of values observed in the reference dataset. If the parametric models fitted to the data correctly match the underlying data distributions, then overall quality (i.e. accuracy) of the explanations may quantitatively improve because the generated data instances can explore parts of the ML model's multidimensional latent space that may be encountered by future realistic instances (even if the precise feature values in the generated instances were not observed in the reference dataset). Likewise, this approach may decrease the number of instances that must be generated to obtain an explanation of equal quality, thereby decreasing consumption of time and space. As explained herein, this approach counterintuitively can both decrease instances and increase explanation accuracy, which is more or less impossible with Shapley based techniques where instances and accuracy are naturally positively correlated.

Data distribution is crucial for realism. Perturbing an original instance to generate a new instance may lead to out-of-distribution samples. Unrealistic data is problematic because it may confuse an ML model, which decreases accuracy of inferencing such as classification. In other words, unrealistic instances occur in regions of a multidimensional problem space where the ML model is unreliable or even unstable such as prone to unpredictable discontinuities in the prediction solution space that prevent an instance from being modified or used as-is in the real world as predicted. Thus, unrealistic instances have little explanatory value and may undermine confidence in MLX.

Important global and local MLX use cases are interactive and do not tolerate latency well. Customer experience (CX) may be at stake. For example, local MLX may be used during a phone conversation such as with a support or sales agent. A localized neighborhood of perturbed instances should be quickly generated. Optimizing the above concerns and criteria is expensive with high dimensional datasets having many constituent datatypes.

In an embodiment, a computer assigns a respective probability distribution to each of many features that include a first feature and a second feature. The first feature and the second feature have different probability distributions. For each original tuple in one or more original tuples that are based on the features, a machine learning (ML) model infers a respective original inference of one or more original inferences. For each feature, and for each original tuple, the computer: a) generates perturbed values based on the probability distribution of the feature, b) generates perturbed tuples that are based on the original tuple and a respective perturbed value, c) causes the ML model to infer a respective perturbed inference for each perturbed tuple, and d) measures a respective difference between each perturbed inference of the perturbed tuples and the original inference. For each feature, a respective importance of the feature is calculated based on the differences measured for the feature. Feature importance attributions may be used to rank features by influence and/or generate a global or local ML explainability (MLX) explanation.

### 1.0 Example Computer

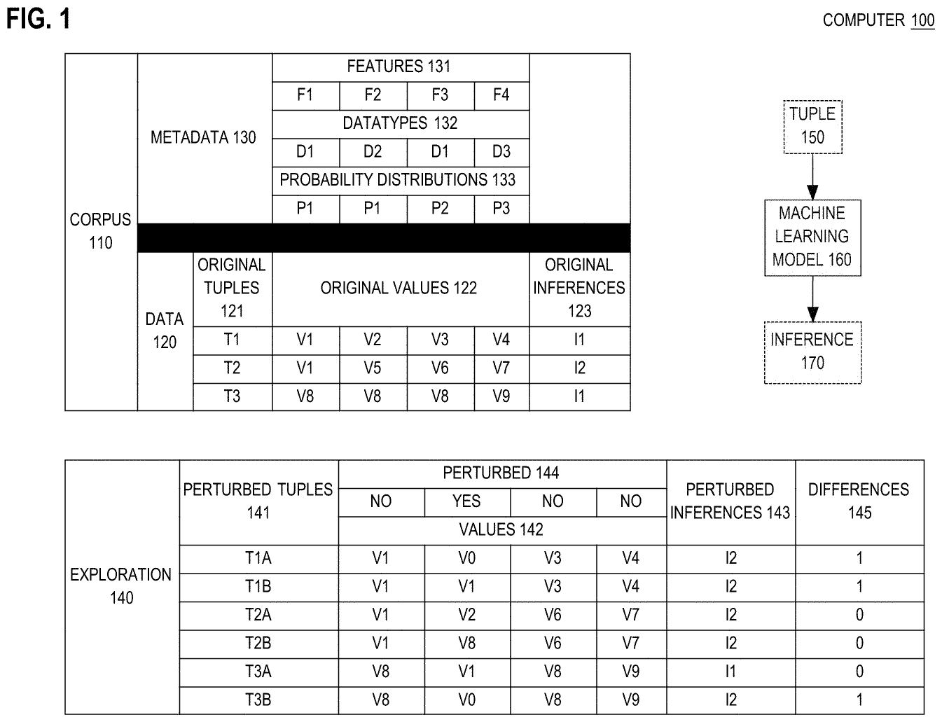

FIG. 1 is a block diagram that depicts an example computer 100, in an embodiment. Computer 100 provides machine learning (ML) explainability (MLX) for black box ML model 160 based on selection of probability distributions 133 for perturbation. As explained herein, perturbing original tuples 121 to generate perturbed tuples 141 may cause reclassification by ML model 160 from original inferences 123 to perturbed inferences 143 that have measurable differences 145. Based on differences 145, features 131 may be scored and ranked for relative importance from which global or local MLX explanations are generated. Computer 100 may be one or more of a rack server such as a blade, a personal computer, a mainframe, a virtual computer, a smartphone, or other computing device.

### 1.1 Black Box Model

In various embodiments, hosted in memory of computer 100 is already-trained ML model 160 that may operate for classification, regression, prediction, anomaly detection, clustering, or other ML purpose. In operation, ML model 160 is applied to a tuple such as tuple 150 to generate an inference such as inference 170 that may be a class or a value of a regression or prediction. In an embodiment, inference 170 contains one or more numeric scores or probabilities such as a respective probability for each of multiple classes. In an embodiment, inference 170 is numeric and compared to a threshold to detect whether or not tuple 150 is anomalous. Tuples are explained later herein.

ML model 160 may be a black-box model that has an unknown, opaque, or confusing architecture that more or less precludes direct inspection and interpretation of the internal operation of ML model 160. In an embodiment not shown, ML model 160 is hosted in a different computer that is not computer 100, and computer 100 applies techniques herein by remotely using ML model 160. For example, computer 100 may send tuple 150 to ML model 160 over a communication network and responsively receive inference 170 over the communication network. For example, computer 100 and ML model 160 may be owned by different parties and/or hosted in different data centers. In various embodiments that host ML model 160 in computer 100, techniques herein may or may not share an address space and/or operating system process with ML model 160. For example, inter-process communication (IPC) may or may not be needed to invoke ML model 160.

### 1.2 Machine Learning Explainability (MLX)

Embodiments herein variously generate global or local explanations of ML model 160. As explained later herein, a local explanation explains one inference 170 by ML model 160 for one tuple 150 that may be known or new. A global explanation instead explains how ML model 160 inferences for: a) many known original tuples 121 of corpus 110, and b) any possible new tuple. As explained below, corpus 110 and/or ML model 160 participate in a sequence of phases that include: training of ML model 160, baselining of ML model 160, analysis of corpus 110, exploration 140, and MLX invocation that generates a global or local explanation.

In various scenarios, tuple 150, inference 170, and/or ML model 160 are reviewed for various reasons. MLX herein can provide combinations of any of the following functionalities:
Explainability: The ability to explain the global or local reasons behind a global label or a local inference
Interpretability: The level at which a human can understand the explanation
Local Explanations: Understand why inference 170 occurred
What-If Explanations: Understand how changes in tuple 150 may or may not cause same inference 170
Model-Agnostic Explanations: Explanations treat ML model 160 as a black box, instead of using properties from ML model 160 to guide the explanation

For example, the explanation may be needed for regulatory compliance. Likewise, the explanation may reveal an edge case that causes ML model 160 to malfunction for which retraining with different data or a different hyperparameters configuration is needed.

### 1.3 Corpus of Original Tuples

Training of ML model 160 entails a training corpus that contains training tuples. In various embodiments, the training corpus is or is not corpus 110. In a preferred embodiment, ML model 160 is supervised, which means that training of ML model 160 is supervised and the tuples of the training corpus are each labeled with a respective known correct inference. In various embodiments explained later herein, training ML model 160: a) is or is not supervised, and b) occurs on computer 100 or a different computer. In any case, ML model 160 is already trained in FIG. 1.

Corpus 110 may or may not be used in any of training, validation, and testing of ML model 160. In an embodiment, corpus 110 is used to establish a baseline landscape that can reveal global behavior of ML model 160. Whether during training, validation, testing, or separate baselining, ML model 160 is applied to original tuples 121 to generate respective original inferences 123. Essentially, original tuples 121 are some or all of a multidimensional problem space, with each of features 131 providing a respective dimension, that ML model 160 can map to original inferences 123 that provide an additional dimension to some or all of a multidimensional solution space.

### 1.4 Corpus Metadata

Corpus 110 includes metadata 130 and data 120 that computer 100 stores or has access to. In an embodiment, metadata 130 is stored or cached in volatile memory, and data 120 is stored in nonvolatile storage that is local or remote. Data 120 defines the multidimensional problem and solution spaces and includes original tuples 121 and original inferences 123. Original tuples 121 are respective points in the multidimensional problem space. Original tuples 121 includes individual original tuples T1-T3 that collectively contain original values 122 that includes individual values V1-V9. Each of original tuples 121 contains a respective value for each of features 131 that includes individual features F1-F4. For example as shown, the value of feature F1 in original tuples T1-T2 is value V1.

Metadata 130 generalizes or otherwise describes data 120. Metadata 130 includes features 131, datatypes 132, and probability distributions 133. Features 131 and datatypes 132 can describe tuple 150 that is shown with a dashed outline to demonstrate that tuple 150 may be any individual tuple of tuples 121 or 141.

### 1.5 Feature Engineering

Tuple 150 contains a respective value for each of features 131. In an embodiment, tuple 150 is, or is used to generate, a feature vector that ML model 160 accepts and that contains more or less densely encoded respective values for features 131. Each of features 131 has a respective one of datatypes 132 that includes individual datatypes D1-D3. For example as shown, features F1 and F3 have datatype D1. Any of datatypes 132 may or may not be: a) a number that is an integer or real, b) a primitive type such as a Boolean or text character that can be readily encoded as a number, c) a sequence of discrete values such as text literals that have a semantic ordering such as months that can be readily encoded into respective numbers that preserve the original ordering, or d) a category that enumerates distinct categorical values that are semantically unordered.

Categories are prone to discontinuities that may or may not seemingly destabilize ML model 160 such that different categorical values for a same feature may or may not cause ML model 160 to generate very different inferences. One categorical feature may be hash encoded into one number in a feature vector or n-hot or 1-hot encoded into multiple numbers. For example, 1-hot encoding generates a one for a categorical value that actually occurs in a tuple and also generates a zero for each possible categorical value that did not occur in the tuple.

Tuple 150 may represent various objects in various embodiments. For example, tuple 150 may be or represent a network packet, a record such as a database table row, or a log entry such as a line of text in a console output logfile. Likewise, features 131 may be respective data fields, attributes, or columns that can occur in each object instance. For example, inference 170 may be a binary classification or an anomaly score that indicates whether or not tuple 150 is anomalous such as based on a threshold. When ML model 160 detects an anomaly in a production environment, an alert may be generated to provoke a human or automated security reaction such as terminating a session or network connection, rejecting tuple 150 from further processing, and/or recording, diverting, and/or alerting tuple 150 for more intensive manual or automatic inspection and analysis.

### 1.6 Probability Distributions

Original values 122 may naturally adhere to various probability distributions such as a bell curve or a uniform distribution. In original values 122, each of features 131 may have a different respective probability distribution. A technical problem is that there may be many possible probability distributions that may be respectively more or less descriptive of the values distribution of a feature. For example, a mismatched probability distribution may provide unrealistic values for a feature. A probability distribution may be used as a generator of realistic values for a feature for experimental, exploratory, and/or explanatory purposes as discussed later herein. Related non-patent literature (NPL) STATISTICAL FUNCTIONS (scipy.stats) provides implementations and descriptions of many different probability distributions that may implement probability distributions 133.

In any case and as discussed later herein, computer 100 selects most realistic probability distributions 133 that includes individual probability distributions P1-P3 for features 131. Although each feature has a datatype and an assigned probability distribution, datatypes and probability distributions may be somewhat orthogonal. For example as shown, features F1-F2 have same probability distribution P1 but different datatypes D1-D2. Conversely, features F1 and F3 have same datatype D1 and different probability distributions P1-P2. In any case, probability distributions 133 may be used during exploration 140 to rank the influence of features 131 on the behavior of ML model 160 as follows.

### 1.7 Exploration by Perturbation

ML model 100 generates or previously generated original inferences 123 respectively for original tuples 121. Original inferences 123 includes individual original inferences I1-I2. For example as shown, original inference I1 was inferred for original tuples T1 and T3. Each original tuple combined with its original inference provides a point in the multidimensional solution space. If original tuples 121 were labeled before original inferences 123 are generated, such as for supervised training of ML model 160, then original inferences 123 may be more or less accurate compared to prior labeling.

Exploration 140 generates perturbed tuples 141 that are probabilistic variations of other tuple(s), depending on the embodiment. In the shown embodiment that generates global explanations, perturbed tuples 141 contains multiple (e.g. two as shown) perturbed variations for each of features 131 and each of original tuples 121. Each perturbed tuple is almost a perfect copy of a respective one of original tuples 121, except that the value of one of features 131 is perturbed (i.e. not a copy). Perturbed 144 demonstratively indicates that feature F2 is perturbed in the shown perturbed tuples 141. However, perturbed tuples 141 also contains an equal amount of unshown tuples that respectively perturb each of other features F1 and F3-F4. In other words, perturbed tuples 141 may have some multiple amount of tuples as original tuples 121 has.

Thus, most of values 142 are copies of original values 122 as follows. As shown, perturbed tuples T1A-T1B are copies of original tuple T1 but with respective perturbed values V0-V1 for feature F2 that instead had original value V2 in original tuple T1. Perturbed values are randomly generated according to the probability distribution of the feature, and the probability distribution is bounded by the same value range as the original values of the feature. For example if original values 122 has a minimum value of 27.4 and a maximum value of 53.1 for feature F2, then probability distribution P1 only generates values in that range for feature F2. However, feature F1 may have a different value range than feature F2, and same probability distribution P1 may generate values in the different range for feature F1.

In an embodiment, all probability distributions 133 generate random real numbers that are inclusively or exclusively between zero and one, and such a real number can be shifted and scaled to fit any probability distribution in any range. For example, an embodiment may have only one random number generator that all probability distributions 133 share. In various embodiments, a perturbed tuple should not match: a) the original tuple from which it was generated, b) any other original tuple, and/or c) any other perturbed tuple. For example if a randomly generated perturbed value causes such a match, then another perturbed value may be randomly and repeatedly generated until a unique perturbed tuple is generated.

For example, exploration 140 may be designed to only generate perturbed tuples having novel combinations of features values. Likewise, values 142 may contain a perturbed value for a feature that does not occur for that feature and/or any other feature in original values 122. For example as shown, value V1 occurs for feature F2 in values 142 but not for feature F2 in original values 122. Likewise as shown, value V0 occurs for feature F2 in values 142 but not for any of features 131 in original values 122.

### 1.8 Supervised Difference Measurement

Because perturbed tuples T1A-T1B are imperfect copies of original tuple T1, ML model 160 may generate same or, as shown, different inferences I1-I2 for almost identical tuples T1 and T1A-T1B. In various embodiments discussed below, differences 145 are measured differences between perturbed inferences 143 and either known correct labels or original inferences 123. Inference 170 is shown with a dashed outline to demonstrate that inference 170 may be any individual inference of inferences 123 or 143.

In a preferred embodiment: a) ML model 160 is supervised, b) original tuples 121 are labeled with respective known correct inferences, and c) loss of any inference as compared to a label may be quantified such as by F1 score for classification or by R² score for regression. As explained earlier herein, some of original inferences 123 may be inaccurate and thus have nonzero loss.

Unless a perturbed tuple is an exact duplicate of an original tuple, perturbed tuples 141 are unlabeled. Loss for a perturbed tuple is measured with the perturbed inference and the label of the original tuple, not the original inference. Thus, perturbed loss and original loss may or may not be equal because the perturbed inference and the original inference may or may not be identical. In that embodiment, the difference between original inference I1 and perturbed inference I2 is an arithmetic (e.g. subtraction) difference between original loss and perturbed loss, and squaring or absolute value may be used to ensure a non-negative difference.

### 1.9 Unsupervised Difference Measurement

In various other embodiments, difference measurement instead is unsupervised and does not use or does not have known correct labels for original tuples 121. In an embodiment, ML model 160 is reconstructive (and usually unsupervised), which means that the output of ML model 160 includes, in addition to inference 170, a reconstruction that is a more or less exact copy of tuple 150. For example, ML model 160 may be an autoencoder as discussed later herein. Loss, although used as discussed above for the preferred embodiment, is instead reconstruction loss that is quantified by comparing input tuple 150 to the output reconstruction that, in some embodiments, is based on aggregating losses of features 131 individually. Reconstruction loss compares either an original tuple to its reconstruction or a perturbed tuple to its reconstruction. If ML model 160 internally generates a reconstruction but outputs neither the reconstruction nor its loss, then computer 100 can access the internal reconstruction to measure loss in an embodiment where ML model 160 is not a black box.

When neither labels, loss, nor reconstruction is available, unsupervised difference measurement may instead occur by measuring the difference between original inference I1 and perturbed inference I2 as follows. When original inference and perturbed inference are identical, the difference is zero. If the inferences are not identical for a categorical feature, a constant nonzero value such as one is used as a difference as shown. Otherwise, a difference may be measured by arithmetic subtraction, in which case squaring or absolute value may be used to ensure non-negative values.

For example if inferences I1 and I2 are numbers such as scores, probabilities, counts, or amounts, then subtraction may measure their difference. Subtraction may also measure differences for values of a sequential range such as months. For example, inference I1 may be two that represents February, inference I2 may be five that represents May, and their difference may be 5−2=three.

In an embodiment, differences are statistical and instead measured in units such as standard deviations based on the statistical distribution of original inferences 123 for the feature. For example, inference 170 may be a threat level in a logarithmic range from 0-5, in which case the statistical difference between zero and one may be one standard deviation that is less than the statistical difference between four and five that may instead be multiple standard deviations.

### 1.10 Importance Scores

As explained above, perturbed tuples 141 only shows perturbations of feature F2 but also contains unshown perturbed tuples for other features. Thus, each of features 131 has an equal count of measurements in differences 145 even though only measurements for feature F2 are shown. Thus, each of features 131 has its own set of differences from which a same aggregate statistic may be derived such as mean, mode, or maximum. That aggregate statistic may be used as a respective importance score for each of features 131. Features 131 may be ranked (i.e. sorted) by importance score to establish a relative ordering of influence of features 131 on the inferential operation of ML model 160.

For example based on shown measurements, the average difference for feature F2 is 0.5. Likewise, the average difference for feature F1 may be 0.2. In that case, feature F2 is more influential than feature F1 on the operation of ML model 160. Thus, feature F2 should have more explanatory power for MLX than does feature F1. Thus, a global explanation of ML model 160 would emphasize feature F2 over feature F1.

Within memory of computer 100, a global or local explanation may be a data structure that is based on or contains a ranking of features 131 by importance score and/or exclude a threshold count of least influential features or features whose importance score falls below a threshold. For example a global explanation may be limited to a top two most influential features or a variable count of features having an importance score of at least 0.4. Explanation generation, including local explanations, are discussed later herein.

### 2.0 Example Supervised Importance Scoring

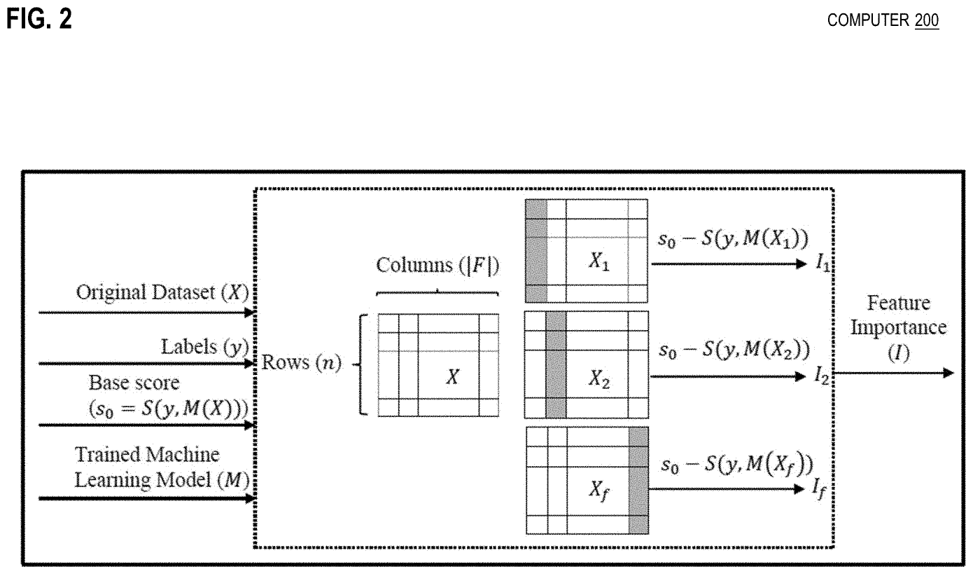

FIG. 2 is a dataflow diagram that depicts example processing by an example computer 200, in an embodiment. Computer 200 implements supervised difference measurement and importance scoring as discussed earlier herein. Computer 200 may be an implementation of computer 100.

As shown, data flows from left to right from inputs on the left to internal and intermediate data structures in the middle to outputs on the right. Inputs are as follows.
Original dataset X is original tuples 121 and original values 122.
Labels y are known correct labels for original tuples 121.
Trained machine learning model M is ML model 160.
M(X) is original inferences 123.
S( ) is a loss function for supervised measurement of loss.
Base score s₀ are the losses of original inferences 123 such as during baselining as discussed above.

As shown by arrows on the left, the inputs are injected into a nested and dashed rectangle in which internal and intermediate data are shown that are as follows.
X is original values 122.
Rows n is original tuples 121.
Columns F is features 131.
X₂ is the subset shown in FIG. 1 of perturbed tuples 141 that perturbs feature F2.
Likewise, X₁ is perturbed tuples for feature F1, and X_{f} is perturbed tuples for feature F4, and a shaded column indicates which feature is perturbed in the subset of perturbed tuples.
M(X₂) is the subset shown in FIG. 1 of perturbed inferences 143 for perturbed tuples X₂.
I₂ is the importance score for feature F2, which is an aggregate difference between original loss and perturbed loss for feature F2 as discussed earlier herein and shown as a subtraction above the arrow that points to I₂.

The output is feature importances I for all features 131 that may be sorted to rank features 131 by influence.

### 3.0 Example Importance Scoring Process

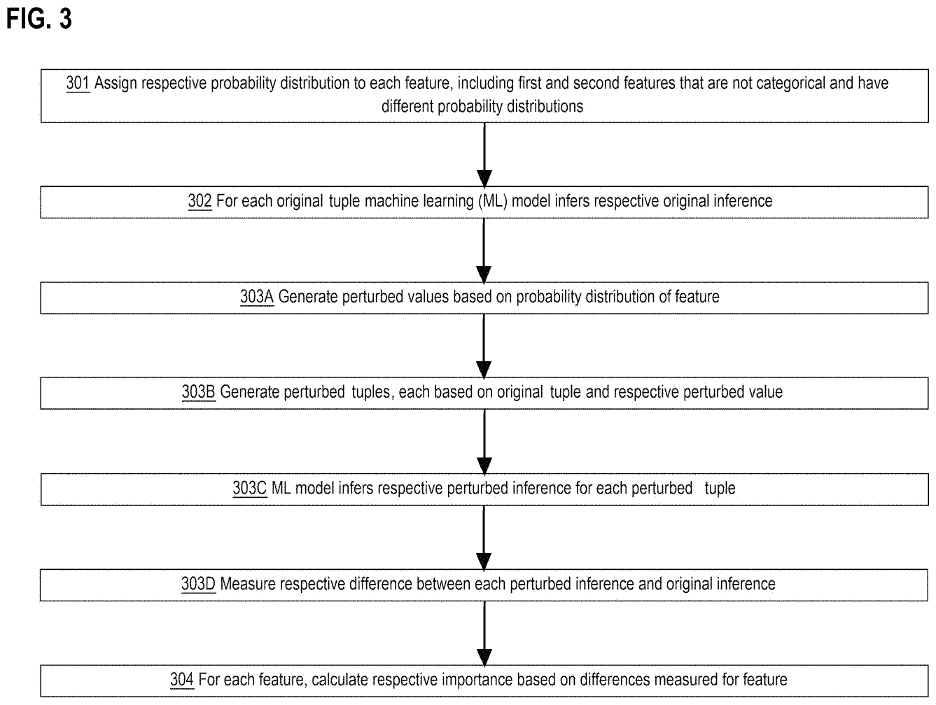

FIG. 3 is a flow diagram that depicts an example process that an embodiment of computer 100 may perform to provide machine learning (ML) explainability (MLX) for black box ML model 160 based on selection of probability distributions 133 for perturbation. FIG. 3 is discussed with reference to FIG. 1.

Steps 301-302 use corpus 110 that has original tuples 121 that may be read only. Steps 301-302 may be reordered, simultaneous, combined, performed on separate respective computers, and/or either or both may be performed during training, validating, testing, or baselining of ML model 160 as discussed elsewhere herein.

Step 301 initializes probability distributions 133, after which probability distributions 133 may be read only. Step 301 assigns a respective probability distribution to each of features 131. In an embodiment, features 131 includes first and second features that are not categorical and have different probability distributions. For example, features F1 and F3 have datatype D1 that may be non-categorical such as numeric, and features F1 and F3 have different respective probability distributions P1 and P2 that may respectively be Poisson and geometric probability distributions. Mechanisms for data-driven selection of probability distributions 133 from an unshown larger inventory of available probability distributions is discussed later herein. Also as discussed later herein, data-driven selection of probability distributions 133 entails statistical analysis of original values 122 on a per feature basis.

For a feature that has a categorical datatype, a histogram having as many bins as distinct categorical values and populated based on the values of the categorical feature in original values 122 may implement a probability distribution for the categorical feature. In various embodiments, the histogram does or does not have bins for categorical values that are defined for a categorical datatype but that do not occur in the values of one or all of the features of that categorical datatype. For example, a categorical primary color probability distribution may or may not include yellow when original values 122 has red and blue but not yellow. If yellow should be included, then the yellow bin is assigned a low non-zero probability.

For horizontal scaling, step 301 may be concurrently performed by a separate execution context respectively for each of features 131 or batched subsets thereof. An execution context may be a lightweight thread, an operating system process, a hyper thread, a processing core of a central processing unit (CPU), a CPU, a coprocessor, and/or a separate computer.

Step 302 populates original inferences 123, after which original inferences 123 may be read only. For each of original tuples 121, ML model 160 infers a respective one of original inferences 123. Some of original inferences 123 may or may not match labels of corresponding original tuples 121 such as with supervised training of ML model 160. For pipeline parallelism, separate pipeline stages may implement respective steps 301-302 in either ordering.

Steps 303A-D are repeated for each of features 131 and each of original tuples 121. That is, steps 303A-D are repeated for each exhaustive distinct pairing of a feature with an original tuple. For example, three repetitions of steps 303A-D are needed for feature F1 of original tuple T1, feature F1 of original tuple T2, and feature F2 of original tuple T2.

Steps 303A-B may be combined to populate a subset of rows shown in perturbed tuples 141 and values 142 that correspond to a feature paired with an original tuple. That subset of rows is a fixed count of perturbed tuples that step 303B generates. Each of those perturbed tuples is based on the original tuple and, as provided by step 303A, a respective perturbed value for the feature. Step 303A generates perturbed values for the feature based on the probability distribution of the feature. For example as shown, step 303B may generate perturbed tuples T1A-T1B as copies of original tuple T1 and, in perturbed tuples T1A-T1B, step 303A may provide perturbed values for feature F2.

Exhaustive repetition of steps 303A-B fully populates perturbed tuples 141 and values 142. Exhaustive repetition of step 303C fully populates perturbed inferences 143. Step 303C applies ML model 160 to each perturbed tuple in the subset of rows of perturbed tuples 141 to cause ML model 160 to infer respective perturbed inferences that may or may not match the original inference of the original tuple.

Exhaustive repetition of step 303D fully populates differences 145. Step 303D measures respective differences between each perturbed inference of the subset of rows of perturbed inferences 143 and, depending on the embodiment, either the known correct label or the original inference of the original tuple as explained earlier herein. For horizontal scaling, steps 303A-D may be concurrently performed by a separate execution context respectively for each of features 131 and/or for each of original tuples 121 or batched subsets thereof.

In an embodiment, a portion of metadata 130 for one or more of features 131 is sent to a respective execution context. For example, steps 303A-B may be combined into an execution context that: a) receives input that includes feature F2, datatype D2, probability distribution P2, and one or more unperturbed tuples and b) responsively generates multiple perturbed tuples for each unperturbed tuple based on the received portion of metadata 130. For example, that execution context may generate the shown subset of perturbed tuples 141.

For pipeline parallelism additionally or instead, a first pipeline stage may perform steps 303A-B, a second may perform step 303C, and a third may perform step 303D. For example, the third stage may measure inference differences for perturbed tuples T1A-T1B while the second stage generates perturbed inferences for tuples T2A-T2B while the first stage generates perturbed tuples T3A-T3B.

For each of features 131, step 304 calculates a respective importance based on inference differences measured for the feature as explained earlier herein. After step 304, computer 100 may: a) rank features 131 and/or retain their respective importance scores, b) discard data 120 and/or exploration 140, and/or c) generate MLX explanations for ML model 160 as discussed elsewhere herein.

### 4.0 Example Explanation Process

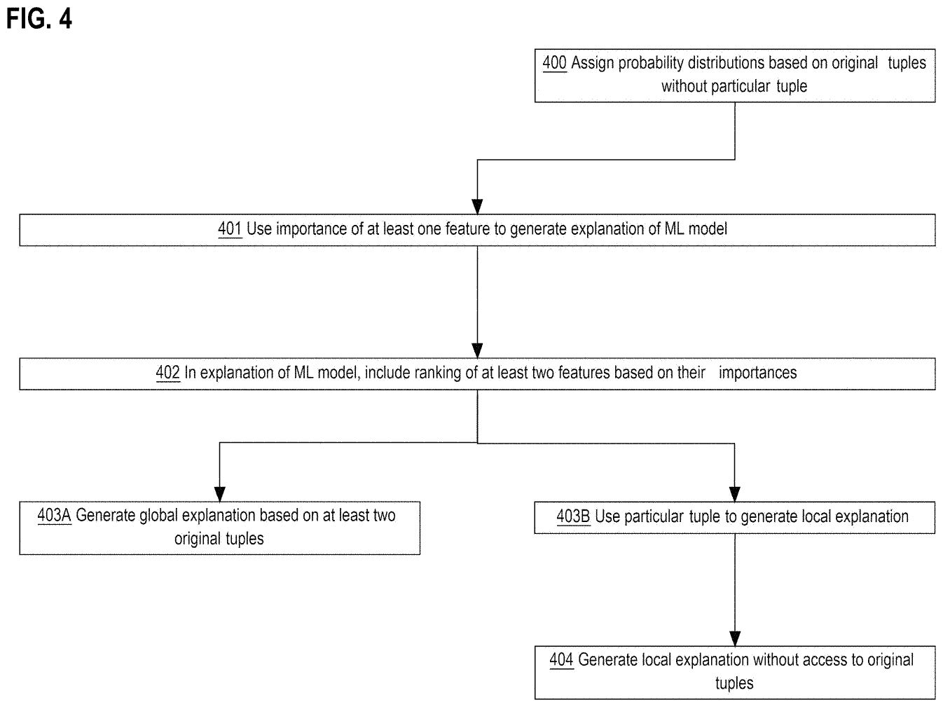

FIG. 4 is a flow diagram that depicts an example process for generating an MLX explanation for ML model 160. FIG. 4 is discussed with reference to FIG. 1.

The steps of FIG. 4 show various activities that various embodiments may or may not use to generate a global explanation or a local explanation. Some of the steps are shown only on the left or right side of FIG. 4. Steps on the left are only performed when generating a global explanation. Steps on the right are only performed when generating a local explanation. For example, steps 403A-B are mutually exclusive. Steps that span the whole width of FIG. 4 may be performed regardless of whether the generated explanation is global or local. Regardless of which kind of explanation is generated by which steps, the process of FIG. 4 generates only one explanation. Thus, performance of multiple steps that expressly mention generating an explanation are cooperatively generating a same explanation.

Regardless of whether the generated explanation is global or local, probability distributions 133 are selected based on original values 122 on a per feature basis as discussed earlier and later herein. In other words, selection of probability distributions 133 is data driven according to original tuples 121. As explained earlier herein, a local explanation explains why ML model 160 made a particular inference for a particular tuple. In various scenarios, original tuples 121 does or does not contain the particular tuple.

For example, the particular tuple may have recently arisen in the wild after original tuples 121 was populated, such as in a live production environment for ML model 160, and has an inference that needs a local explanation for purposes of regulatory compliance, customer satisfaction, or quality control. Alternatively, the particular tuple may be experimental, exploratory, or speculative such as an intentionally counterfactual variation of one of original tuples 121 or an interesting one of perturbed tuples 141, any of which may need a local explanation for purposes of software development lifecycle (SDLC).

Thus for local explaining only, step 400 may assign probability distributions 133 to features 131 based on original tuples 121 and without the particular tuple. For example, the particular tuple might not yet exist when step 400 occurs. That is although step 400 is for local explaining only, step 400 is not itself localized, because the particular tuple either does not yet exist or has not yet attracted attention deserving of a local explanation.

Steps 401-402 occur regardless of whether the generated explanation is global or local. Step 401 uses importance score(s) of one, some, or all of features 131 to generate the explanation of ML model 160. For example, the explanation may contain or expressly refer to a feature that is the most influential and/or that is the only feature with an importance score exceeding a threshold.

In the generated explanation of ML model 160, step 402 includes a ranking for at least two features based on their importance scores. For example, the explanation may indicate which feature is the most influential and which other feature is the second most influential, or the explanation may rank a subset of features whose importance scores exceed a threshold. The explanation may indicate rank by express ordinal or by visual sorting and/or may contain importance scores.

Mutually exclusive steps 403A-B occur while generating an explanation that is respectively global or local. Step 403A generates a global explanation based on at least two original tuples such as some or all of original tuples 121. For example as discussed earlier herein, step 403A may be based on feature importance scores that are based on perturbed tuples 141 that are based on original tuples 121.

Step 403B uses a particular tuple to generate a local explanation. In an embodiment that retains data 120, step 403B may generate a local explanation that contains or is based on a tiny subset of original tuples 121 that: a) caused ML model 160 to generate a same inference as the particular tuple, b) have identical values as the particular tuple for a subset of features 131 with highest importance scores, and b) have various values that differ from the particular tuple for the remaining others of features 131.

In an embodiment, step 404 instead generates a local explanation without access to data 120. For example during explanation generation, data 120 may be restricted, discarded, or may be too large to retrieve. Such an embodiment may differ from other embodiments herein as follows. Perturbed tuples 141 are based on the particular tuple instead of original tuples 121. Differences 145 are based on the inference of the particular tuple instead of original inferences 123.

Instead of generating a hundred thousand perturbed tuples 141 from a thousand original tuples 121, an embodiment may generate five hundred or five thousand perturbed tuples 141 from the particular tuple. That embodiment generates fewer perturbed tuples 141 but, counterintuitively, generates a more accurate local explanation. That is because that embodiment concentrates perturbed tuples 141 to a small neighborhood of the multidimensional problem space that surrounds the particular tuple, thereby further localizing the explanation.

Because the size of perturbed tuples 141 is a fixed and unrelated to original tuples 121 for a local explanation, this local technique has linear complexity, which is less than other local explanation techniques. The local embodiment is well suited to horizontal scaling with a cluster of computers because data 120 need not be distributed to the cluster that generates the local explanation. Additional complementary local explanation techniques are presented in related U.S. patent application Ser. No. ______.

### 5.0 Example Importance Scoring Activities

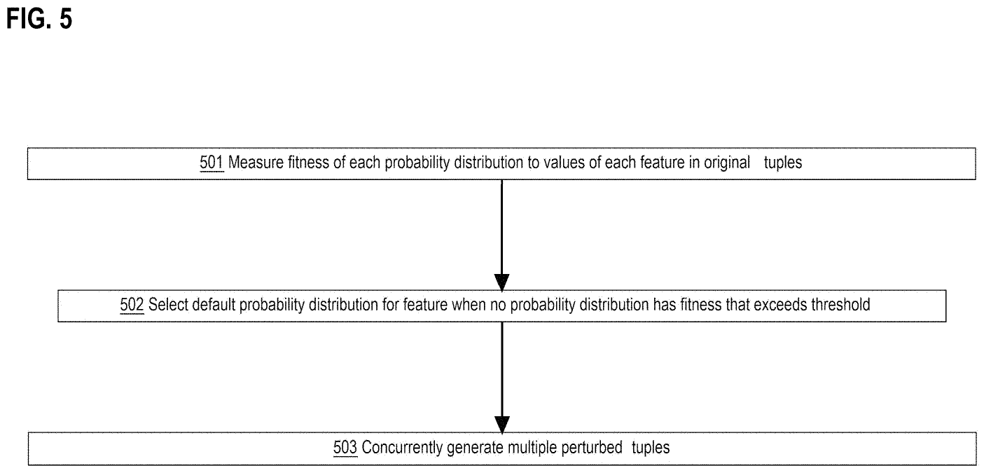

FIG. 5 is a flow diagram that depicts an example process for scoring features 131 for importance in an embodiment. FIG. 5 is discussed with reference to FIG. 1.

As discussed earlier herein, computer 100 may have many available probability distributions and select a best few for probability distributions 133. Also as explained earlier herein, which probability distribution is best for one feature may not be best for another feature, even if both features share a same datatype. Step 501 measures the fitness of each available probability distribution to original values 122 of each of features 131 separately. In an embodiment, the Kolmogorov-Smirnov fitness test, such as provided in related non-patent literature (NPL) STATISTICAL FUNCTIONS (scipy.stats), is used to measure the fitness of each of many probability distributions for a feature.

If no probability distribution has a measured fitness for a feature that exceeds a threshold, then step 502 selects a default probability distribution for that feature. In an embodiment, the default probability distribution is a uniform probability distribution that has an equal probability for every value in the range of values for the feature. For example if values of feature F1 range from −22.3 to 4.5 in original values 122, then any value in that range is equally likely by default, even if feature F1 has a statistical mode in original values 122.

As explained earlier herein, each of features 131 is perturbed in a fixed multiple count of respective perturbed tuples generated from each of original tuples 121. That is, each of features 131 has a same sized subset of perturbed tuples 141. Step 503 uses multiple execution contexts to concurrently generate multiple perturbed tuples. For example, each execution context may variously generate, inference, and/or difference: a) all perturbed tuples that perturb a same feature, b) all perturbed tuples that perturb a same original tuple, or c) all perturbed tuples that perturb a same feature and a same original tuple. Each of (a)-(c) generates and/or processes perturbed tuples 141 in subsets of various sizes that may be combined into batches of multiple subsets such as when a count of subsets much exceeds a count of execution contexts. In an embodiment, un-generated and/or unprocessed subsets collectively are a backlog from which execution contexts may repeatedly race to take a next subset until the backlog is empty.

### 6.0 Example Pseudocode to Select Probability Distributions

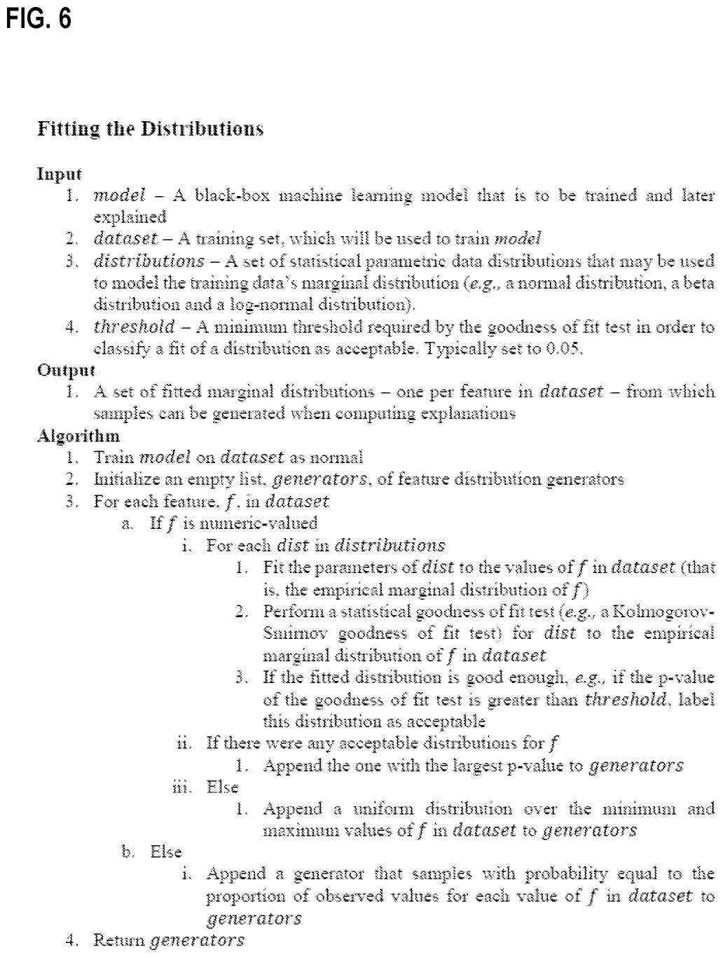

FIG. 6 depicts example pseudocode that computer 100 may implement in an embodiment. The pseudocode initializes probability distributions 133 by selecting a best fitting probability distribution respectively for each of features 131. FIG. 6 is discussed with reference to FIG. 1. The pseudocode accepts the following inputs.
Model is ML model 160.
Dataset is original tuples 121 and original values 122.
Distributions are many available probability distributions such as provided in related non-patent literature (NPL) STATISTICAL FUNCTIONS (scipy.stats).
Threshold is a minimum fitness score below which an available probability distribution is automatically disqualified from inclusion in probability distributions 133 for a feature, although the same available probability distribution may have a higher fitness for another feature and thus possibly be included in probability distributions 133 for the other feature.

Generators is the output of the pseudocode that, respectively for features 131, operate as random variables that apply probability distributions 133 to datatypes 132 within value ranges for features 131 as discussed earlier herein.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

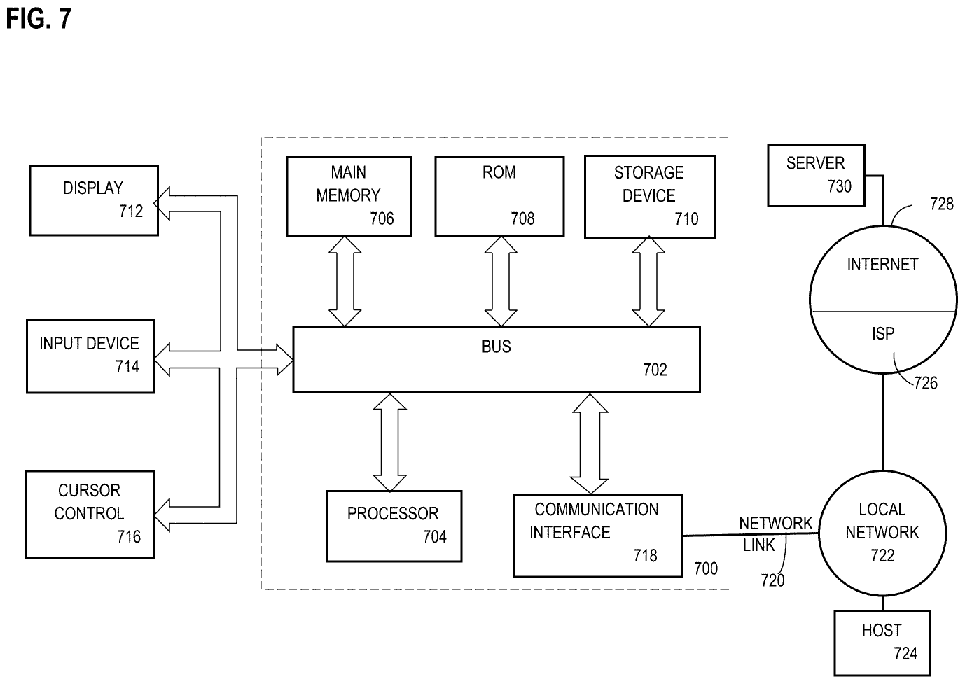

For example, FIG. 7 is a block diagram that illustrates a computer system 700 upon which an embodiment of the invention may be implemented. Computer system 700 includes a bus 702 or other communication mechanism for communicating information, and a hardware processor 704 coupled with bus 702 for processing information. Hardware processor 704 may be, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk, optical disk, or solid-state drive is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 710. Volatile media includes dynamic memory, such as main memory 706. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid-state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

### Software Overview

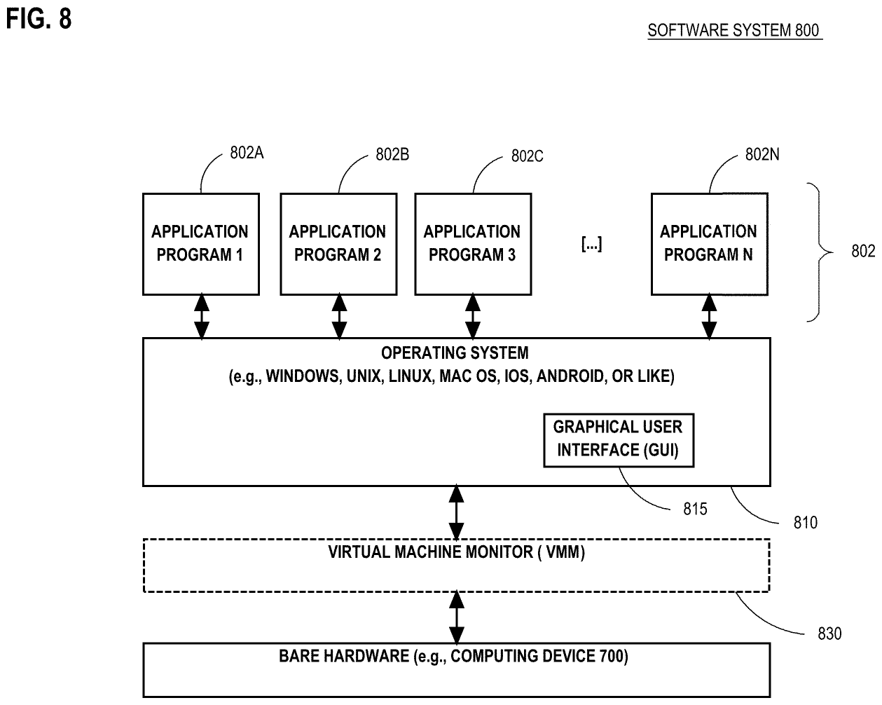

FIG. 8 is a block diagram of a basic software system 800 that may be employed for controlling the operation of computing system 700. Software system 800 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 800 is provided for directing the operation of computing system 700. Software system 800, which may be stored in system memory (RAM) 706 and on fixed storage (e.g., hard disk or flash memory) 710, includes a kernel or operating system (OS) 810.

The OS 810 manages low-level aspects of computer operation, including managing execution of processes, memory allocation, file input and output (I/O), and device I/O. One or more application programs, represented as 802A, 802B, 802C . . . 802N, may be “loaded” (e.g., transferred from fixed storage 710 into memory 706) for execution by the system 800. The applications or other software intended for use on computer system 700 may also be stored as a set of downloadable computer-executable instructions, for example, for downloading and installation from an Internet location (e.g., a Web server, an app store, or other online service).

Software system 800 includes a graphical user interface (GUI) 815, for receiving user commands and data in a graphical (e.g., “point-and-click” or “touch gesture”) fashion. These inputs, in turn, may be acted upon by the system 800 in accordance with instructions from operating system 810 and/or application(s) 802. The GUI 815 also serves to display the results of operation from the OS 810 and application(s) 802, whereupon the user may supply additional inputs or terminate the session (e.g., log off).

OS 810 can execute directly on the bare hardware 820 (e.g., processor(s) 704) of computer system 700. Alternatively, a hypervisor or virtual machine monitor (VMM) 830 may be interposed between the bare hardware 820 and the OS 810. In this configuration, VMM 830 acts as a software “cushion” or virtualization layer between the OS 810 and the bare hardware 820 of the computer system 700.

VMM 830 instantiates and runs one or more virtual machine instances (“guest machines”). Each guest machine comprises a “guest” operating system, such as OS 810, and one or more applications, such as application(s) 802, designed to execute on the guest operating system. The VMM 830 presents the guest operating systems with a virtual operating platform and manages the execution of the guest operating systems.

In some instances, the VMM 830 may allow a guest operating system to run as if it is running on the bare hardware 820 of computer system 700 directly. In these instances, the same version of the guest operating system configured to execute on the bare hardware 820 directly may also execute on VMM 830 without modification or reconfiguration. In other words, VMM 830 may provide full hardware and CPU virtualization to a guest operating system in some instances.

In other instances, a guest operating system may be specially designed or configured to execute on VMM 830 for efficiency. In these instances, the guest operating system is “aware” that it executes on a virtual machine monitor. In other words, VMM 830 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Machine Learning Models

A machine learning model is trained using a particular machine learning algorithm. Once trained, input is applied to the machine learning model to make a prediction, which may also be referred to herein as a predicated output or output. Attributes of the input may be referred to as features and the values of the features may be referred to herein as feature values.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depends on the machine learning algorithm.

In supervised training, training data is used by a supervised training algorithm to train a machine learning model. The training data includes input and a “known” output. In an embodiment, the supervised training algorithm is an iterative procedure. In each iteration, the machine learning algorithm applies the model artifact and the input to generate a predicated output. An error or variance between the predicated output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria is met.

In a software implementation, when a machine learning model is referred to as receiving an input, being executed, inferring or inferencing, and/or generating an output or predication, a computer system process executing a machine learning algorithm applies the model artifact against the input to generate a predicted output. A computer system process executes a machine learning algorithm by executing software configured to cause execution of the algorithm. When a machine learning model is referred to as performing an action, a computer system process executes a machine learning algorithm by executing software configured to cause performance of the action.

Inferencing entails a computer applying the ML model to an input such as a feature vector to generate an inference by processing the input and content of the ML model in an integrated way. Inferencing is data driven according to data, such as learned coefficients, that the ML model contains. Herein, this is referred to as inferencing by the ML model that, in practice, is execution by a computer of an ML algorithm that processes the ML model.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e. configurable) implementations of best of breed machine learning algorithms may be found in open source libraries such as Google's TensorFlow for Python and C++ or Georgia Institute of Technology's MLPack for C++. Shogun is an open source C++ ML library with adapters for several programing languages including C#, Ruby, Lua, Java, MatLab, R, and Python.

### Artificial Neural Networks

An artificial neural network (ANN) is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (MLP), each layer comprises a group of neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neuron.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input neuron, the activation value is simply an input value for the input. For an activation neuron, the activation value is the output of the respective activation function of the activation neuron.

Each edge from a particular neuron to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron's activation value is an input to the activation neuron's activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation neuron, the activation function of the neuron is applied to the weighted activation values and the bias.

### Illustrative Data Structures for Neural Network

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L−1 to a layer L. Given the number of neurons in layer L−1 and L is N[L−1] and N[L], respectively, the dimensions of matrix W is N[L−1] columns and N[L] rows.

Biases for a particular layer L may also be stored in matrix B having one column with N[L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input neuron. The particular input may be stored as vector. Training data comprises multiple inputs, each being referred to as sample in a set of samples. Each sample includes a value for each input neuron. A sample may be stored as a vector of input values, while multiple samples may be stored as a matrix, each row in the matrix being a sample.

When an input is applied to a neural network, activation values are generated for the hidden layers and output layer. For each layer, the activation values for may be stored in one column of a matrix A having a row for every neuron in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of neurons and/or edges determines the size of matrices needed to implement a neural network. The smaller the number of neurons and edges in a neural network, the smaller matrices and amount of memory needed to store matrices. In addition, a smaller number of neurons and edges reduces the amount of computation needed to apply or train a neural network. Less neurons means less activation values need be computed, and/or less derivative values need be computed during training.

Properties of matrices used to implement a neural network correspond neurons and edges. A cell in a matrix W represents a particular edge from a neuron in layer L−1 to L. An activation neuron represents an activation function for the layer that includes the activation function. An activation neuron in layer L corresponds to a row of weights in a matrix W for the edges between layer L and L−1 and a column of weights in matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that is not parallelizable. Thus, network depth (i.e. amount of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix based implementations of an ANN and matrix operations for feed forward processing are readily available and parallelizable in neural network libraries such as Google's TensorFlow for Python and C++, OpenNN for C++, and University of Copenhagen's fast artificial neural network (FANN). These libraries also provide model training algorithms such as backpropagation.

### Backpropagation

An ANN's output may be more or less correct. For example, an ANN that recognizes letters may mistake an I as an L because those letters have similar features. Correct output may have particular value(s), while actual output may have somewhat different values. The arithmetic or geometric difference between correct and actual outputs may be measured as error according to a loss function, such that zero represents error free (i.e. completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depends on the gradient of the error at each edge. Gradient of an edge is calculated by multiplying the edge's error delta times the activation value of the upstream neuron. When the gradient is negative, the greater the magnitude of error contributed to the network by an edge, the more the edge's weight should be reduced, which is negative reinforcement. When the gradient is positive, then positive reinforcement entails increasing the weight of an edge whose activation reduced the error. An edge weight is adjusted according to a percentage of the edge's gradient. The steeper is the gradient, the bigger is adjustment. Not all edge weights are adjusted by a same amount. As model training continues with additional input samples, the error of the ANN should decline. Training may cease when the error stabilizes (i.e. ceases to reduce) or vanishes beneath a threshold (i.e. approaches zero). Example mathematical formulae and techniques for feedforward multilayer perceptron (MLP), including matrix operations and backpropagation, are taught in related reference “EXACT CALCULATION OF THE HESSIAN MATRIX FOR THE MULTI-LAYER PERCEPTRON,” by Christopher M. Bishop.

Model training may be supervised or unsupervised. For supervised training, the desired (i.e. correct) output is already known for each example in a training set. The training set is configured in advance by (e.g. a human expert) assigning a categorization label to each example. For example, the training set for optical character recognition may have blurry photographs of individual letters, and an expert may label each photo in advance according to which letter is shown. Error calculation and backpropagation occurs as explained above.

### Autoencoder

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g. anecdotal) or otherwise incomplete understanding of a problem space by a human expert. Whereas, unsupervised training discovers an apt intermediate vocabulary based more or less entirely on statistical tendencies that reliably converge upon optimality with sufficient training due to the internal feedback by regenerated decodings. Techniques for unsupervised training of an autoencoder for anomaly detection based on reconstruction error is taught in non-patent literature (NPL) “VARIATIONAL AUTOENCODER BASED ANOMALY DETECTION USING RECONSTRUCTION PROBABILITY”, Special Lecture on IE. 2015 Dec. 27; 2(1):1-18 by Jinwon An et al.

### Principal Component Analysis

Principal component analysis (PCA) provides dimensionality reduction by leveraging and organizing mathematical correlation techniques such as normalization, covariance, eigenvectors, and eigenvalues. PCA incorporates aspects of feature selection by eliminating redundant features. PCA can be used for prediction. PCA can be used in conjunction with other ML algorithms.

### Random Forest

A random forest or random decision forest is an ensemble of learning approaches that construct a collection of randomly generated nodes and decision trees during a training phase. Different decision trees of a forest are constructed to be each randomly restricted to only particular subsets of feature dimensions of the data set, such as with feature bootstrap aggregating (bagging). Therefore, the decision trees gain accuracy as the decision trees grow without being forced to over fit training data as would happen if the decision trees were forced to learn all feature dimensions of the data set. A prediction may be calculated based on a mean (or other integration such as soft max) of the predictions from the different decision trees.

Random forest hyper-parameters may include: number-of-trees-in-the-forest, maximum-number-of-features-considered-for-splitting-a-node, number-of-levels-in-each-decision-tree, minimum-number-of-data-points-on-a-leaf-node, method-for-sampling-data-points, etc.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
assigning a respective probability distribution to each feature of a plurality of features that include a first feature and a second feature that are not categorical, wherein the first feature and the second feature have different probability distributions;
for each original tuple in one or more original tuples that are based on the plurality of features, a machine learning (ML) model inferring a respective original inference of one or more original inferences;
for each feature of the plurality of features, for each original tuple in the one or more original tuples:
generating a plurality of perturbed values based on the probability distribution of the feature,
generating a plurality of perturbed tuples, wherein each perturbed tuple of the plurality of perturbed tuples is based on the original tuple and a respective perturbed value of the plurality of perturbed values,
the ML model inferring a respective perturbed inference for each perturbed tuple of the plurality of perturbed tuples, and
measuring a respective difference between each perturbed inference of the plurality of perturbed tuples and the original inference;
for each feature of the plurality of features, calculating a respective importance of the feature based on the differences measured for the feature.

2. The method of claim 1 further comprising at least one selected from the group consisting of:
generating at least one value of the plurality of perturbed values of a particular feature that does not occur for the particular feature in said plurality of original tuples, and
generating an explanation of the ML model based on the importance of at least one feature of the plurality of features.

3. The method of claim 2 wherein the explanation comprises at least one selected from the group consisting of:
a global explanation that is based on the one or more original tuples, wherein the one or more original tuples are at least two original tuples,
a local explanation that is based on the one or more original tuples, wherein the one or more original tuples is a particular tuple,
a ranking of at least two features of the plurality of features based on the importances of the at least two features.

4. The method of claim 3 wherein said assigning probability distributions is based on a plurality of original tuples that does not include said particular tuple.

5. The method of claim 4 wherein said generating said local explanation occurs without access to said plurality of original tuples.

6. The method of claim 1 wherein said assigning probability distributions is based on the one or more original tuples.

7. The method of claim 6 wherein said assigning the probability distribution to each feature of a plurality of features comprises selecting the probability distribution from a plurality of probability distributions.

8. The method of claim 7 wherein said selecting the probability distribution comprises measuring fitness of each probability distribution of the plurality of probability distributions to the one or more original tuples.

9. The method of claim 8 wherein said selecting the probability distribution comprises at least one selected from the group consisting of:
measuring Kolmogorov-Smirnov fitness based on the one or more original tuples, and
selecting a default probability distribution when a threshold exceeds all said fitnesses of the plurality of probability distributions.

10. The method of claim 9 wherein the default probability distribution is a uniform probability distribution.

11. The method of claim 1 wherein said measuring the respective difference comprises measuring a respective difference between a respective loss of each perturbed inference of the plurality of perturbed tuples and a loss of the original inference.

12. The method of claim 1 wherein at least one selected from the group consisting of:
the ML model is unsupervised, and
the one or more original tuples are unlabeled.

13. The method of claim 1 further comprising two execution contexts concurrently performing said generating two respective perturbed tuples of the plurality of perturbed tuples.

14. One or more non-transitory computer-readable media storing instructions that, when executed by one or more processors, cause:
assigning a respective probability distribution to each feature of a plurality of features that include a first feature and a second feature that are not categorical, wherein the first feature and the second feature have different probability distributions;
for each original tuple in one or more original tuples that are based on the plurality of features, a machine learning (ML) model inferring a respective original inference of one or more original inferences;
for each feature of the plurality of features, for each original tuple in the one or more original tuples:
generating a plurality of perturbed values based on the probability distribution of the feature,
generating a plurality of perturbed tuples, wherein each perturbed tuple of the plurality of perturbed tuples is based on the original tuple and a respective perturbed value of the plurality of perturbed values,
the ML model inferring a respective perturbed inference for each perturbed tuple of the plurality of perturbed tuples, and
measuring a respective difference between each perturbed inference of the plurality of perturbed tuples and the original inference;
for each feature of the plurality of features, calculating a respective importance of the feature based on the differences measured for the feature.

15. The one or more non-transitory computer-readable media of claim 14 wherein the instructions further cause at least one selected from the group consisting of:
generating at least one value of the plurality of perturbed values of a particular feature that does not occur for the particular feature in said plurality of original tuples, and
generating an explanation of the ML model based on the importance of at least one feature of the plurality of features.

16. The one or more non-transitory computer-readable media of claim 15 wherein the explanation comprises at least one selected from the group consisting of:
a global explanation that is based on the one or more original tuples, wherein the one or more original tuples are at least two original tuples,
a local explanation that is based on the one or more original tuples, wherein the one or more original tuples is a particular tuple,
a ranking of at least two features of the plurality of features based on the importances of the at least two features.

17. The one or more non-transitory computer-readable media of claim 14 wherein said assigning probability distributions is based on the one or more original tuples.

18. The one or more non-transitory computer-readable media of claim 17 wherein said assigning the probability distribution to each feature of a plurality of features comprises selecting the probability distribution from a plurality of probability distributions.

19. The one or more non-transitory computer-readable media of claim 14 wherein said measuring the respective difference comprises measuring a respective difference between a respective loss of each perturbed inference of the plurality of perturbed tuples and a loss of the original inference.

20. The one or more non-transitory computer-readable media of claim 14 wherein the instructions further cause two execution contexts concurrently performing said generating two respective perturbed tuples of the plurality of perturbed tuples.
